(19) United States
(12) Patent Application Publication
(10) Pub. No.: US 2007/0145801 A1
(43) Pub. Date: Jun. 28, 2007

(54) Seat reclining device for vehicle

(75) Inventors: Yukifumi Yamada, Toyota-shi (JP); Yasuhiro Kojima, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/607,984

(22) Filed: Dec. 4, 2006

(30) Foreign Application Priority Data
Dec. 16, 2005 (JP) 2005-363957

(51) Int. Cl. B60N 2/02; B60N 2/48

(52) U.S. Cl. 297/369

(57) ABSTRACT

A vehicle seat reclining device includes a lock mechanism at each side of the vehicle seat for restricting or allowing a rotational movement of a seat back relative to a seat cushion. The lock mechanism includes a cam mechanism rotating around a rotational axis of the seat back relative to the seat cushion for restricting or allowing the relative rotation between the seat back and the seat cushion. The cam mechanism includes an engagement hole and a first shaft provided at the lock mechanism having an engagement portion engaging with the engagement hole with a clearance The other side lock mechanism includes a second shaft and a connecting portion for connecting the second shaft with the first shaft, wherein the second shaft is connected with the first shaft in such a manner that a rotation position of the second shaft is adjusted to agree with a rotation allowing timing of the relative rotation between the seat back and the seat cushion by the lock mechanisms.

### CROSS REFERENCE TO RELATED APPLICATION

This application is based on and claims priority under 35 U.S.C. §119 with respect to Japanese Patent Application 2005-363957, filed on Dec. 16, 2005, the entire content of which is incorporated herein by reference.

### FIELD OF THE INVENTION

The present invention is generally directed to a seat reclining device for a vehicle seat

### BACKGROUND

In an automobile seat, various kinds of seat reclining device have been applied. Basically, the seat reclining device is used for reclining a seat back relative to a seat cushion. The reclining device includes a lock mechanism, which allows or restricts rotational movement of the seat back relative to the seat cushion to allow an occupant to select any desired seated posture and to keep him or her to the selected position. The lock mechanism is usually provided at each side of the seat to smoothly perform reclining operation.

As an example of such lock mechanism used in a seat device, Japanese Patent No.2002-112849A discloses a seat reclining device, which includes a pair of lock mechanisms, provided at right and left sides of a seat each at one side. As shown in the attached drawings of the Japanese Patent No. 2002-112849A, the two lock mechanisms are provided with a cam (5), which rotates around a rotation axis of the seat back. The rotation movement of the cam forces the pawl member (4) in a radial direction to engage with or disengage from an upper plate. The engagement and disengagement between the pawl and the upper plate serve as a locking or unlocking function to restrict or allow the rotational movement of the seat back relative to the seat cushion.

The both lock mechanisms of this state of art are directly connected by a shaft (6) and integrally rotated by the engagement of the projection portions (6a) formed at both ends of the shaft and the holes (53) provided on the cam. An operation lever is provided at one of the end of the shaft. When the lever is operated, the cams are rotated through the shaft.

A clearance is provided in a rotational direction between each projection portion of the shaft and each hole of the cam for smooth rotation. However, a timing of engagement or disengagement may be differed between the two lock mechanisms by the following reasons: Non-alignment between the two lock mechanisms due to an assembling error upon assembling the seat cushion and the seat back; and rotational angle deviation between the cams due to deviation caused by degree of accuracy of teeth portions and dimension accuracy of contact portion between the cam and the pawl. As shown in FIG. 7 of the attached drawings of this application, in order to improve the alignment between the two lock mechanisms, two-shaft structure has been proposed, one shaft at the right side and the other at the left side. Each shaft has the engaging portion at both ends for engaging the holes of the cams. In the drawing, each lock mechanism 90 includes a shaft 92 having the engaging portion 92a for engaging with a hole 91a of the cam 91. Each shaft 92 has a cylindrical axial portion 92b provided in axial direction opposing to each other. These shafts 92 are disposed so that the releasing (unlocking) timing at both sides may correspond to each other after the seat frame structure has been assembled. The two shafts 92 are then connected to a cylindrical connecting bar 93 in which the cylindrical axial portions 92b are inserted and welded together with the bar 93.

The two lock mechanisms are integrated together after the releasing timing agreed to each other. When the operation force is applied to one of the shafts 92, the force is then transmitted to the other shaft through the bar 93 to release the locking of the lock mechanisms at the same time.

Although this structure can eliminate the timing difference between the two lock mechanisms stated above, the number of parts increases (such as two shafts and one connecting bar) and the manufacturing process may increase (such as welding process).

Considering the above problems for the state of art reclining device, the invention pertains an improved seat reclining device, which has less number of parts and less manufacturing processes and still improves the lock releasing timing deviation.

### SUMMARY

According to the invention, the vehicle seat reclining device includes a first lock mechanism at one side of the vehicle seat and a second lock mechanism at the other side of the vehicle seat for restricting or allowing a rotational movement of a seat back relative to a seat cushion, the first lock mechanism including a first cam mechanism and the second lock mechanism including a second cam mechanism, both cam mechanisms rotating around a rotational axis of the seat back relative to the seat cushion for restricting or allowing the relative rotation between the seat back and the seat cushion. The first cam mechanism includes a first engagement hole and the second cam mechanism includes a second engagement hole, the first and the second engagement holes have the same shape with each other. The lock mechanism further includes a first shaft provided at the first lock mechanism and having a first engagement portion engaging with the first engagement hole with a clearance, a second engagement portion provided at the second lock mechanism and having the same outer profile with the first engagement portion and engaging with the second engagement hole and a second shaft provided at the second lock mechanism and having a connecting portion for connecting the second shaft with the first shaft, wherein the second shaft is connected with the first shaft in such a manner that a rotation position of the second shaft is adjusted to agree with a rotation allowing timing of the relative rotation between the seat back and the seat cushion by the first and the second lock mechanisms.

### BRIEF DESCRIPTION OF DRAWINGS

These and other objects of the invention will be more clearly understood by the following description of the preferred embodiments with reference to the attached drawings, in which:

FIG. 1 is an exploded perspective view of a seat reclining device according to an embodiment of the invention;

FIG. 2 is a cross sectional view of the seat reclining device of the embodiment illustrated in FIG. 1;

FIG. 3 is an exploded perspective view showing a lock mechanism used in the reclining device;

FIG. 4 is a front view of the lock mechanism in FIG. 3;

FIG. 5 is a similar view to FIG. 4, but showing another embodiment of the lock mechanism of the invention;

FIG. 6 is a cross sectional view of the lock mechanism in FIG. 5; and

FIG. 7 is a cross sectional view showing a conventional lock mechanism.

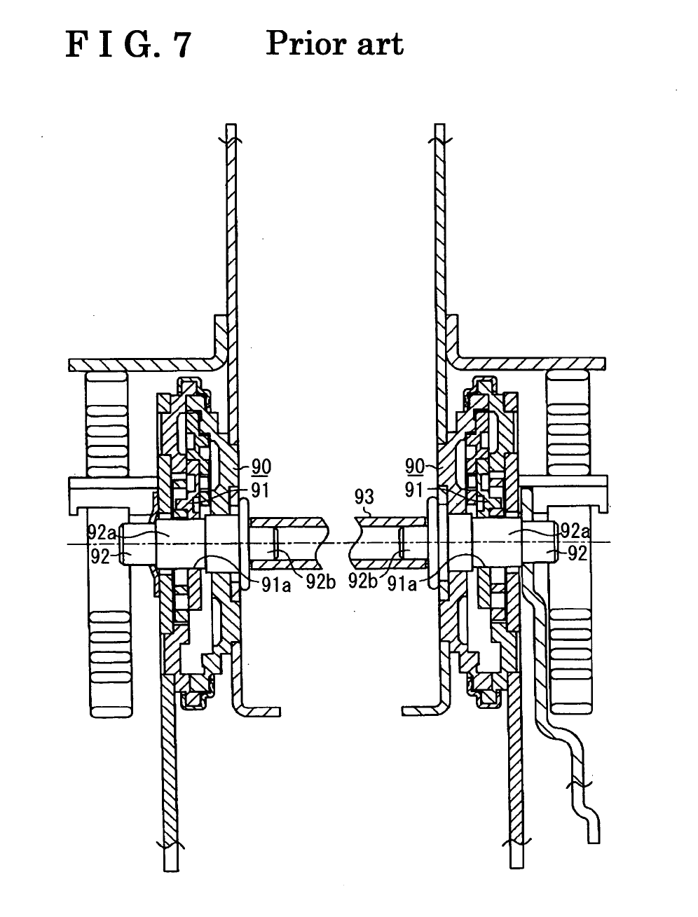

### DETAILED DESCRIPTION

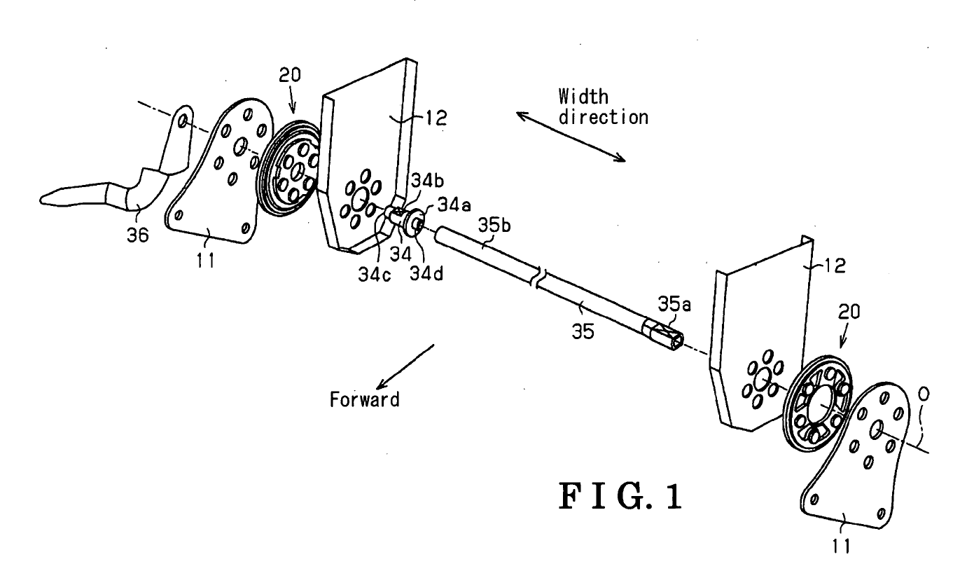

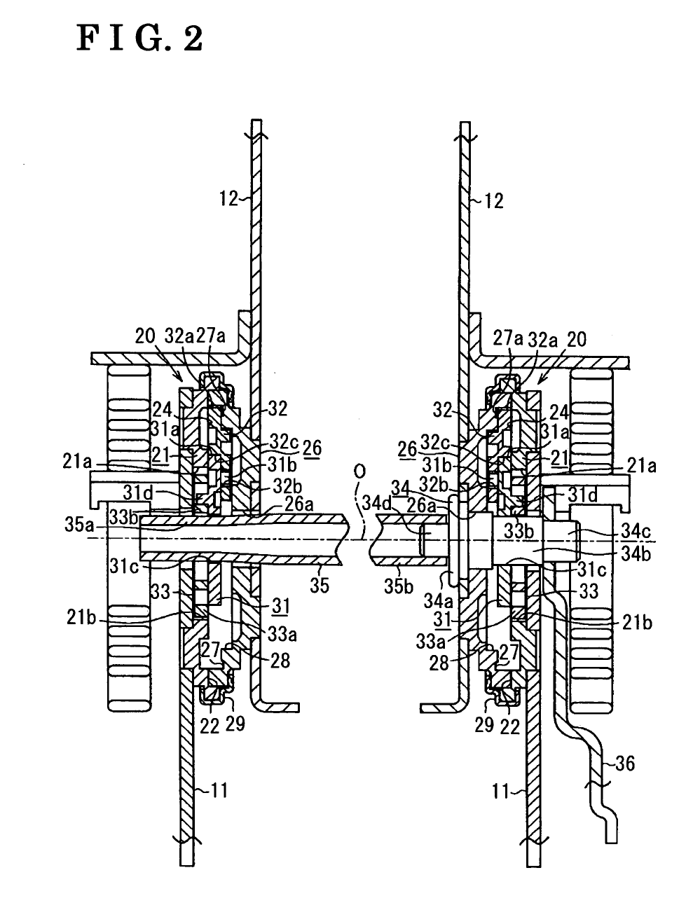

FIGS. 1 and 2 show a vehicle seat reclining device having a seat cushion frame 11 (partially shown), a seat back frame 12 (partially shown) and a lock mechanism 20. The seat cushion frame is a framework of a seat cushion (not shown) for a vehicle seat and the seat back frame 12 is a framework of a seat back (not shown) for the vehicle seat. Both frames 11 and 12 are made by a metal plate to support the seat cushion and the seat back. Each frame 11 and 12 is provided at both sides of the seat in width direction relative to the vehicle. The seat back frame 12 is rotatably connected to the seat cushion frame 11 via a lock mechanism 20 and rotatable around the rotational axis O of the seat back frame 12 relative to the seat cushion frame 11.The lock mechanism 20 (first lock mechanism 20, second lock mechanism 20) is provided at each side of the seat in width direction relative to the vehicle. The lock mechanisms 20 restrict or allow the rotational movement of the seat back frame 12 relative to the seat cushion frame 11. Basically, the seat back frame, and accordingly, the seat back thereon are rotated relative to the seat cushion frame (the seat cushion in this embodiment.

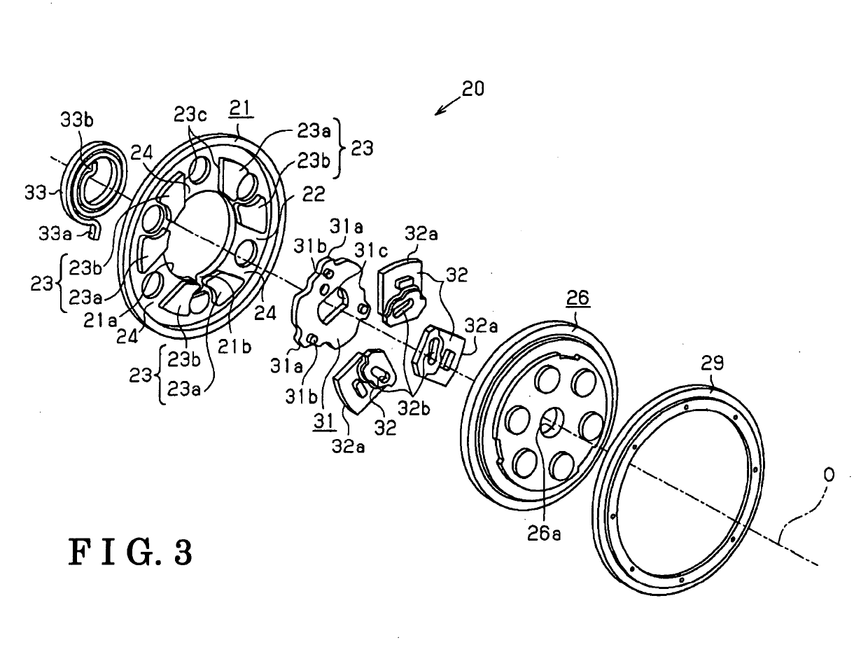

Referring now to the detail of the structure of the lock mechanisms with reference to FIG. 3, the lock mechanisms 20 of each side has the same structure and explanation will be made for the one at the right side.

A lower plate 21 is welded to the inside surface of the seat cushion frame 11 and made by half blanking process. The lower plate 21 includes a ring shaped through-hole 21a at its center and an engagement hole 21b formed consecutively with the through-hole 21a. The engagement hole 21b is provided in a radial and outward direction from the inner surface of the through hole 21b.

A recessed portion 22 is formed on the lower plate 21 circularly at the opposing side of the seat cushion frame 11. A plurality of projections 23 (in this embodiment, three projections) is provided on the recessed portion 22 each with a predetermined angle interval. Each projection 23 has two seated portions 23a and 23b divided in a circumferential direction. Each separated portion 23a and 23b has a parallel flat side surface 23c, which opposes a parallel flat side surface 23c of the other portion 23b, 23a in a radial direction. A guide groove 24 is formed between the parallel flat side surfaces of the projections 23 in a radial direction

As shown in FIGS. 2 and 3, an upper plate 26 is welded to the inner surface of the seat back frame 12 and formed by half-blanking process. The upper plate 26 is formed with a ring-shaped axial through-hole 26a through which a shaft 35 (explained later in detail) is inserted. The outer diameter of the upper plate 26 is approximately the same with the inner diameter of the recessed portion 22 of the lower plate 21 so that the upper plate 26 and the lower plate 21 can be relatively slidable. In other words, the upper plate 26 is freely rotatably supported on the lower plate 21 through the sliding movement of the upper plate relative to the lower plate for relative rotational movement of the seat back frame 12 to which the upper plate 26 is welded relative to the seat cushion frame 11.

As shown in FIG. 2, the upper plate 26 is formed circularly with a first recessed portion 27 at opposite side of the seat back frame 12 (lower plate facing side). The first recessed portion 27 is provided with a toothed portion 27a (inner tooth) at the inner surface thereof. The toothed portion 27a is arranged to oppose the guide groove 24 in a radial direction. The upper plate 26 is further formed with a second recessed portion 28 coaxially with the first recessed portion 27, but having a smaller inner diameter than the first recessed portion 27.

A ring shaped holder 29 made by metal plate is formed to cover or hold the assembled upper and lower plates 21 and 26 so that the holder can allow the relative rotation of the assembly but restrict the axial movement not to be loosed or disassembled.

A cam mechanism 31 (cam member, first cam mechanism, second cam mechanism) is inserted into a space formed by the recessed portion 22 of the lower plate 21 and the first and second recessed portions 27, 28 under the two plates 21 and 26 being assembled. The cam mechanism 31 is made by a metal plate and processed by half-blanking. The cam mechanism 31 is rotatably inserted for rotation about the rotational axis line O as shown in FIG. 2. The cam mechanism 31 includes three cam portions 31a provided on the outer peripheral portion, each being provided with a preset angle interval and extending in a radial and outward direction. The cam mechanism 31 further includes three pin type projections 31b projecting towards the upper plate side in axial direction with parallel to the rotational axis (axial center) O and an axial through hole 31c, the cross section of which is in a flatted circular shape such as oval. The mechanism 31 further includes a pin type projection 31d projecting towards the lower plate side (see FIG. 2) in axial direction and in parallel with the rotational axis line O. The position of the pin type projection 31d has to be agreed with the axial position of the through hole 21a and engagement hole 21b of the lower plate 21 and positions at an intermediate position between the through hole 21a and the engagement hole 31c in radial direction.

Each guide groove 24 is provided for receiving a rectangular shaped pawl member 32 as shown in FIG. 3. Each pawl 32 is movable with the side surface 23c of the projection 23 in a radial direction. The pawl 32 is further formed with an outer-toothed portion 32a, which is engaged with the inner-toothed portion 27a of the upper plate 26 (see FIG. 2) and a cam groove 32b, into which the projection 31b of the cam mechanism 31 is inserted for achieving a cam function. The cam groove 32 is provided with an inclination in a circumferential direction relative to the rotational axis (O).

In each pawl 32, an axial stepped portion is provided between the outer-toothed portion 32a and the cam groove 32b. An opposed surface of the stepped portion in a radial direction serves as a pawl cam surface 31c, which extends with an inclination angle relative to the pitch circle of the outer tee 32a. The pawl 32 is engaged when the tip end of the cam portion 31a contacts with the pawl cam surface 31c.

In other words, when the cam 31 rotates, for an example, in a clockwise direction as viewed in FIG. 3, the cam projections 31b push the pawl 32 to move along the guide groove 24 in a radial inward direction to disengage the toothed engagement between the toothed portions 27a and 32a. The upper plate 26, and accordingly, the seat back frame with the seat back can be inclined relative to the lower plate 21 and seat cushion frame to have the seat back move to a desired posture position.

When the cam mechanism 31 is rotated in the other direction (counterclockwise direction as viewed in FIG. 3), the cam projection 31b pushes the pawl 32 to slide or move the pawl 32 in radial and outward direction to engage the toothed portion 32a with the toothed portion 27a of the upper plate 26 by the engagement of the projection 31b and the cam groove 32b and the contact of the pawl cam surface 32c and the cam portion 31a Thus the relative rotation between the lower plate 21 and the upper plate 26 is restricted to lock the seat back frame 12 relative to the seat cushion frame 11.

A spring 33 is provided at the inner side of the through hole 21a at the central portion of the lower plate 21. The spring is of approximately quadrangle shape in cross section and spirally formed from a wire material. One end 33a of the spring 33 is engaged with the engagement hole 21b of the lower plate 21 and the other end 33b is engaged with the projection 31d of the cam mechanism 31 and the spring 33 always urging the through hole 31c of the cam mechanism 31 axially towards its releasing diction. The spring is wound around the axial center (rotational axis O) of the cam rotational axis. The spring 33 urges the cam mechanism 31 in one direction (in the embodiment, in a counterclockwise direction as viewed in FIG. 3) to restrict the rotational movement thereof relative to the lower plate 21.

Accordingly, the cam mechanism 31 keeps the upper plate 26 to the restricted condition relative to the lower plate 21 by the force of the spring 33 to restrict the rotational movement of the seat back frame 12 to which the upper plate 26 is welded relative to the seat cushion frame 1 to which the lower plate 21 is welded. When the cam mechanism 31 is rotated against the biasing force of the spring 33, the upper plate 26 is released to a rotation condition relative to the lower plate 21.

As mentioned, although one (right side in FIG. 1) of the cam mechanisms 31 has been explained, the other cam mechanism 31 (left side in FIG. 1) has the same structure and function. However, for an explanation purpose the engagement hole at the right side is called as a first engagement hole, whereas the same engagement hole at the left side is called here as a second engagement hole not to mix the right side structure with the left side structure.

In the lock mechanism 20 at the right side, includes a metal made first shaft 34 into which, from inside, the seat back frame 12, the axial through hole 26a of the upper plate 26, the first engagement hole 31c of the cam mechanism 31, the through hole 21a of the lower plate 21 and the seat cushion frame 11 are inserted. The first shaft 34 includes a flange portion 34a extending outwardly, a first engagement portion 34b provided on the flange portion 34a and extending in an axial direction (in the seat cushion frame side) to be engaged with the first engagement hole 31c with a rotational clearance, an attachment portion 34c provided consecutively from the engagement portion 34b in the same axial direction and a column shape axial portion 34d projecting in the opposite axial direction from the flange portion 34a. All these portions are integrally formed with the first shaft 34.

An operation lever 36 for operating the seat back reclining is connected to the first shaft 34. For details, the lever 36 is welded to the first shaft 34 at the seat cushion frame side (one side) of the first shaft 34 in an axial direction. The lever 36 is of an L-shaped and one arm portion of the L shape is used for operation and the other arm is used for welding to the first shaft 34. When the operation lever 36 is operated manually or any other method such as an electric motor to release the engagement of the lower plate 21 and the upper plate 26 by overcoming the spring force of the spring 33 and change the seat reclining device to be in operable or movable condition. The lever 36 is provided at the first shaft 34 to define the position of the first shaft 34 in an axial direction by the lever 36 and the flange portion 34a. In other words, the first shaft 34 is prevented from disengaging from the first lock mechanism 20 in the axial direction by the operation lever 36 and the flange portion 34a. The first engagement portion 34b is arranged to a position corresponding to the first engagement hole 31c and rotated integrally with the cam mechanism 31. The spring 33 is also placed to an axial position corresponding to the positions of the cam mechanism 31 and the first shaft 34 so that the spring can be disposed in alignment for coaxially inserting into the first shaft 34 and the cam mechanism 31.

In the left side lock mechanism 20, a metal made cylindrical second shaft 35 is provided, into which from the inner side, the seat back frame 12, the through hole 21a of the lower plate 21 and the seat cushion frame 11 are inserted The second shaft 35 has its inner diameter approximately the same with the outer diameter of the first shaft 34 and at its one end a second engagement portion 35a is formed to engage with the first engagement hole 31c with a clearance in a rotational direction. The shape of the second engagement portion 35a is approximately oval. The second engagement portion 35a is formed by being pressed to be deformed (for example, by squeeze machining process), and the shape of the second engagement portion 35a is the same with that of the first engagement portion 34b. Therefore, the engagement between the second engagement portion 35a of the second shaft 35 and the engagement holes 31c is the same between the first engagement portion 34b of the first shaft 34 and the engagement holes 31c.

The other end of the second shaft 35 is formed with a connecting portion 35b for connecting the first shaft 34 and the second shaft 35 by inserting the connecting portion 35b into the axial portion 34d for integral rotation. After the seat framework assembly is completed, the connecting portion 35b is inserted into the axial portion 34d of the first shaft 34 by adjusting to agree with the timing of lock releasing (rotation allowing timing) of the relative rotation between the seat back and the seat cushion by the first and the second lock mechanisms 20 between the shafts 34 and 35 and then both shafts are welded for unitary rotation. The assembling error can be adjusted by the clearance provided at the engagement portions (between the first and second engagement holes 31c and the first and the second engagement portions 34b and 35a) by adjustably rotating in the rotational direction.

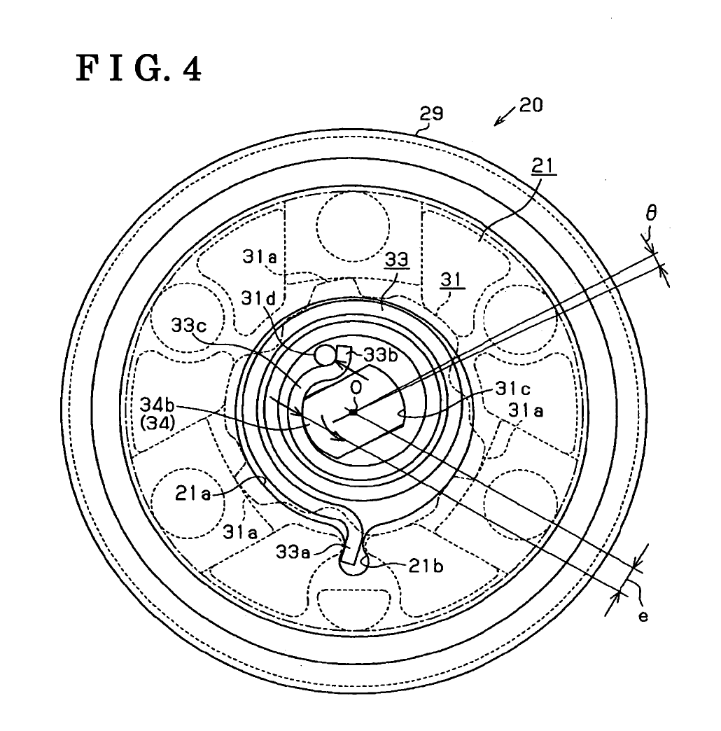

The spring 33 is wound from inside to outside in counterclockwise direction. The outside end 33a is bent in a radial outward direction to be connected to the engagement hole 21b and the inside end 33b is bent in a radial inward direction to be connected to the projection 31d of the cam mechanism 31 with a pressure from the axial center (rotational axis O) side. The spring 33 is provided with a curved portion 33c (see FIG. 4) for elastically pressing the corner of the engagement portion 34b. The curved portion 33c is offset by “e” from the rotation center (rotational axis O) to generate a rotational torque and the first shaft 34 is urged in the counterclockwise direction as viewed in FIG. 4 by the rotational torques

The clearance for engagement of the cam mechanism 31 (engagement hole 31c) and the first shaft 34 (first engagement portion 34b) is provided in a rotational direction, which is shown as an angle θ. The offset amount e is provided to absorb the clearance (or a play θ) by the rotation in the counterclockwise direction, which is the direction to restrict the rotation of the upper plate 26 by the cam mechanism 31.

For the left side lock mechanism 20, the same structure is made to have a clearance θ and the clearance is absorbed by the same manner. (Not shown)

When the operation lever 36 is operated to release the lock mechanism, the operation force is inputted to the first and the second shafts 34 and 35 without clearance θ (without play). Since no play for operation exists, a comfortable operation feeling can be achieved. In other words, first operation stage needs an operation force for rotating the first and the second shafts 34 and 35 overcoming the spring force from the curved portion 33c of the spring 33 and the following stage thereafter needs an operation force for rotating the first and second shafts 34 and 35 together with the cam mechanism 31 overcoming the force of the spring 33 to obtain a moderate operation feeling throughout the operation.

The embodiment of the invention described above may be modified as follows:

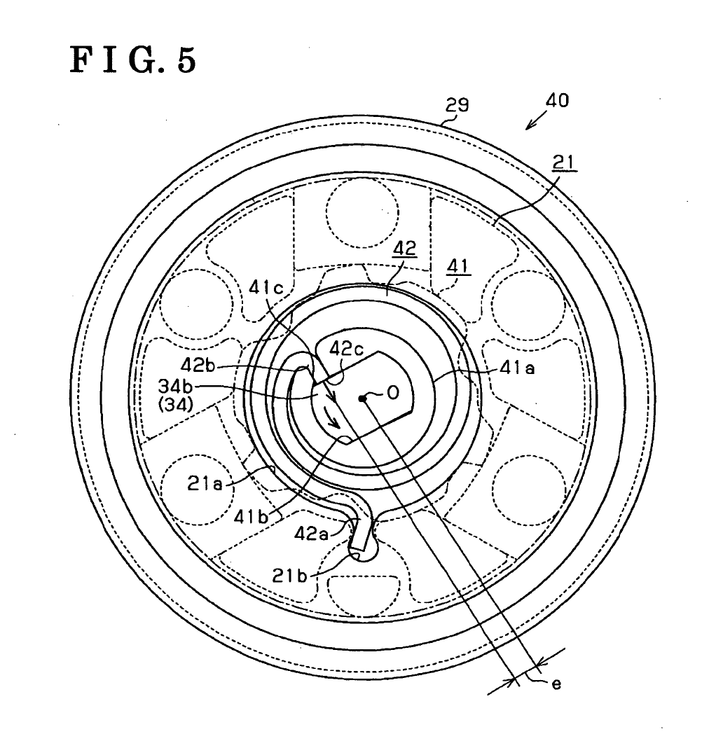

As shown in FIG. 4 and FIG. 5, a modified lock mechanism 40 includes a metal made cam mechanism 41 disposed between the lower plate 21 and the upper plate 26 (inner space). The cam mechanism 41 is rotatable about the rotation axis O and the outer diameter of the cam mechanism 41 is set to be smaller tan the inner diameter of the through hole 21a. The cam mechanism 41 includes a projecting wall portion 41a with a column shape and a flat circular shape engagement hole 41b at the central portion in axial direction. The first engagement portion 34b of the first shaft 34 is engaged with the engagement hole 41b with a clearance in rotational direction.

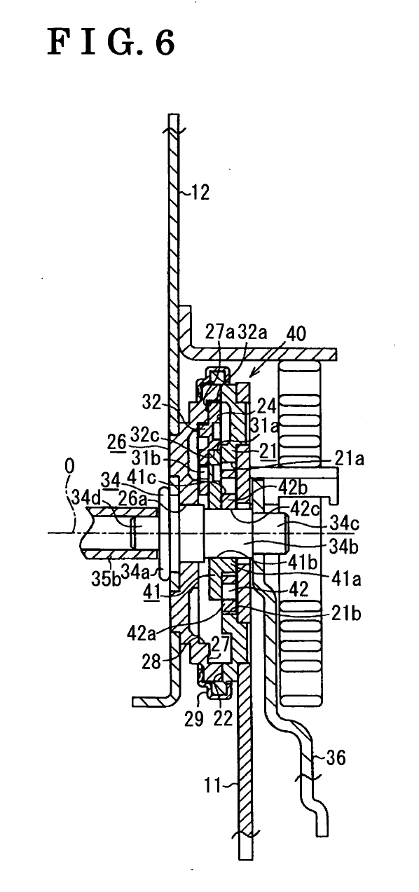

A groove 41c is provided at the projecting wall portion 41a offset with θ from the rotational axis O and extending in a radial direction and open to the engagement hole 41b. As shown in FIG. 6, the groove 42c (projecting wall portion 41a) positions corresponding to the position of the through hole 21a (and 21b) in axial direction under the cam mechanism 41 being disposed between the lower plate 21.

As shown in FIG. 5, a spring 42 having a rectangular shape in cross section is disposed in the central portion of the lower plate 21, i.e., inner surface side of the through hole 21a. One end 42a of the spring 42 is engaged with the engagement hole 21b of the lower plate 21 and the other end 42b is engaged with the groove 41c of the cam mechanism 41. The spring 42 is wound around the rotational axis O of the cam mechanism 41, or the outer peripheral side of the projecting wall portion 41a. The spring 42 always urges the upper plate 26 against rotation relative to the lower plate 21.

The cam mechanism 41 keeps the rotation restriction of the upper plate 26 relative to the lower plate 21 by the biasing force of the spring 42. Accordingly the seat back frame 12 is restricted its relative rotation to the seat cushion frame 11. When the cam mechanism 41 is rotated against the spring force, the upper plate 26 is changed to be in a rotatable condition.

As shown in FIG. 5, the spring 42 is wound from the inner side to the outer side in a counterclockwise direction. The end 42a is inserted and engaged with the engagement hole 21b with bending in a radial outward direction. The other end 42b at the inner side is bent in a radial inward direction and inserted and engaged with the groove 41c.

The end 42b of the spring 42 is guided to the engagement hole 41b side through the groove 41c and is projected toward the engagement hole side. A tip end 42c is provided at the spring 42. The tip end 42c serves as a pressurizing portion to press elastically a corner of the oval shaped first engagement portion 34b. A force is applied on the first shaft 34 with an offset amount θ from the rotational axis O to generate a rotational torque thereby to urge the shaft 41 towards the cam mechanism 41 in a rotational direction. As mentioned a clearance for engagement is provided between the cam mechanism 41 (engagement hole 41b) and the first shaft 34 (first engagement portion 34b), which is a play angle with respect to the rotational axis O. The tip end 42c of the spring 42 presses the first shaft 34 in a rotational direction to restrict the rotation of the upper plate 26 relative to the lower plate 26.

The left side lock mechanism 40 has the same structure to absorb the play angle in a rotational direction between the cam mechanism 41 and the second shaft 35 (not shown).

According to this modified embodiment, the axial lines of shafts 34 and 35 are in agreement (stable) compared to the case where the cam mechanism presses the first and the second shafts 34 and 35 with a deviated position in axial direction from the engagement of the cam mechanism with the shafts 34 and 35. This is because the tip end 42c of the spring 42 presses the shafts 34 and 35 at the position where the cam mechanism 41 engages with the shafts 34 and 35 in an axial direction.

In this embodiment, pressing either the first shaft or the second shaft, instead of pressing both shafts, by the bending portion 33c or the tip end 42c can absorb the clearance.

The operation force for the first and the second shafts may be achieved by using an electric motor. In the embodiment, the shape of the engagement holes 31c, 41b and first and second engagement portions 34b, 35a is an oval shape, but any polygonal shape or D-shape may be used.

The upper plate and lower plate may be arranged in reverse relationship, as long as the plates can be rotated relatively and restricted to achieve the reclining operation of the seat reclining device.

According to the invention, the two lock mechanisms are connected together with the first and second shafts and the welding process needs only at one point between the two shafts. The number of parts and the number of manufacturing process can be decreased to lead to a cost reduction.

According to the embodiment of the invention, since the outer profile of the second engagement portion 35a can be formed by squeezing the end of the cylindrical second shaft, the structure is simple and a general purpose pipe can be used for forming the second shaft to reduce the manufacturing cost and the process.

Since the clearance of engagement portions can be absorbed, abnormal noise when the vehicle is running can be reduced or restricted.

Although some embodiments of the invention have been explained, it is not limited to the embodiments and various other changes and modifications can be possible within the scope of the invention.

The principles, preferred embodiment and mode of operation of the present invention have been described in the foregoing specification. However, the invention which is intended to be protected is not to be construed as limited to the particular embodiment disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle seat reclining device having a first lock mechanism at one side of the vehicle seat and a second lock mechanism at the other side of the vehicle seat for restricting or allowing a rotational movement of a seat back relative to a seat cushion, the first lock mechanism including a first cam mechanism and the second lock mechanism including a second cam mechanism, both cam mechanisms rotating around a rotational axis of the seat back relative to the seat cushion for restricting or allowing the relative rotation between the seat back and the seat cushion, the first cam mechanism including a first engagement hole and the second cam mechanism including a second engagement hole, the first and the second engagement holes having the same shape with each other, a first shaft provided at the first lock mechanism and having a first engagement portion engaging with the first engagement hole with a clearance, a second engagement portion provided at the second lock mechanism and having the same outer profile with the first engagement portion and engaging with the second engagement hole and a second shaft provided at the second lock mechanism and having a connecting portion for connecting the second shaft with the first shaft, wherein the second shaft is connected with the first shaft in such a manner that a rotation position of the second shaft is adjusted to agree with a rotation allowing timing of the relative rotation between the seat back and the seat cushion by the first and the second lock mechanisms.

2. The vehicle seat reclining device according to claim 1, wherein the second shaft is formed of a cylindrical shape and the outer profile of the second engagement portion is formed by being pressed to be deformed.

3. The vehicle seat reclining device according to claim 1, further comprising an operation lever connected to the first shaft at one side thereof in an axial direction and a flange portion provided at the other side of the first shaft in the axial direction, wherein the first shaft is prevented from disengaging from the first lock mechanism in the axial direction by the option lever and the flange portion.

4. The vehicle seat reclining device according to claim 2, further comprising an operation lever connected to the first shaft at one side thereof in an axial direction and a flange portion provided at the other side of the first shaft in the axial direction, wherein the first shaft is prevented from disengaging from the first lock mechanism in the axial direction by the operation lever and the flange portion.

5. The vehicle seat reclining device according to claim 1, wherein the first lock mechanism has a first spring and the second lock mechanism has a second spring, each spring wound around the rotational axis of each cam mechanism, one end of the first spring is engaged with either one of the seat back or the seat cushion and one end of the second spring is engaged with either one of the seat back or the seat cushion, while the other end of the first spring is engaged with the first cam mechanism and the other end of the second spring is engaged with the second cam mechanism to urge the respective cam mechanisms in a rotational direction to restrict the rotation of the seat back relative to the seat cushion and wherein the first spring has a first pressing portion for pressing the first shaft to absorb the clearance between the first engagement hole and the first engagement portion in the rotational direction to restrict the rotation of the seat back relative to the seat cushion and the second spring has a second pressing portion for pressing the second shaft to absorb a clearance provided between the second engagement hole and the second engagement portion in the rotational direction to restrict the rotation of the seat back relative to the seat cushion.

6. The vehicle seat reclining device according to claim 2, wherein the first lock mechanism has a first spring and the second lock mechanism has a second spring, each spring wound around the rotational axis of each cam mechanism, one end of the first spring is engaged with either one of the seat back or the seat cushion and one end of the second spring is engaged with either one of the seat back or the seat cushion, while the other end of the first spring is engaged with the first cam mechanism and the other end of the second spring is engaged with the second cam mechanism to urge the respective cam mechanisms in a rotational direction to restrict the rotation of the seat back relative to the seat cushion and wherein the first spring has a first pressing portion for pressing the first shaft to absorb the clearance between the first engagement hole and the first engagement portion in the rotational direction to restrict the rotation of the seat back relative to the seat cushion and the second spring has a second pressing portion for pressing the second shaft to absorb a clearance provided between the second engagement hole and the second engagement portion in the rotational direction to restrict the rotation of the seat back relative to the seat cushion.

7. The vehicle seat reclining device according to claim 3, wherein the first lock mechanism has a first spring and the second lock mechanism has a second spring, each spring wound around the rotational axis of each cam mechanism, one end of the first spring is engaged with either one of the seat back or the seat cushion and one end of the second spring is engaged with either one of the seat back or the seat cushion, while the other end of the first spring is engaged with the first cam mechanism and the other end of the second spring is engaged with the second cam mechanism to urge the respective cam mechanisms in a rotational direction to restrict the rotation of the seat back relative to the seat cushion and wherein the first spring has a first pressing portion for pressing the first shaft to absorb the clearance between the first engagement hole and the first engagement portion in the rotational direction to restrict the rotation of the seat back relative to the seat cushion and the second spring has a second pressing portion for pressing the second shaft to absorb a clearance provided between the second engagement hole and the second engagement portion in the rotational direction to restrict the rotation of the seat back relative to the seat cushion.

8. The vehicle seat reclining device according to claim 4, wherein the first lock mechanism has a first spring and the second lock mechanism has a second spring, each spring wound around the rotational axis of each cam mechanism, one end of the first spring is engaged with either one of the seat back or the seat cushion and one end of the second spring is engaged with either one of the seat back or the seat cushion, while the other end of the first spring is engaged with the first cam mechanism and the other end of the second spring is engaged with the second cam mechanism to urge the respective cam mechanisms in a rotational direction to restrict the rotation of the seat back relative to the seat cushion and wherein the first spring has a first pressing portion for pressing the first shaft to absorb the clearance between the first engagement hole and the first engagement portion in the rotational direction to restrict the rotation of the seat back relative to the seat cushion and the second spring has a second pressing portion for pressing the second shaft to absorb a clearance provided between the second engagement hole and the second engagement portion in the rotational direction to restrict the rotation of the seat back relative to the seat cushion.

9. The vehicle seat reclining device according to claim 1, wherein the first lock mechanism has a first spring wound around the rotational axis of the first cam mechanism, one end of the first spring is engaged with either one of the seat back or the seat cushion, while the other end of the first spring is engaged with the first cam mechanism to urge the first cam mechanism in a rotational direction to restrict the rotation of the seat back relative to the seat cushion and wherein the first spring has a first pressing portion for pressing the first shaft to absorb the clearance between the first engagement hole and the first engagement portion in the rotational direction to restrict the rotation of the seat back relative to the seat cushion.
